(19) United States
(12) Patent Application Publication
(10) Pub. No.: US 2009/0094177 A1
(43) Pub. Date: Apr. 9, 2009

(54) METHOD FOR EFFICIENT MACHINE-LEARNING CLASSIFICATION OF MULTIPLE TEXT CATEGORIES

(76) Inventor: KAZUO AOKI, Yokohama-City (JP)

Correspondence Address: Dillon & Yudell, LLP, 8911 N. Capital of Texas Hwy., Suite 2110, Austin, TX, 78759, US

(21) Appl. No.: 11/867,955

(22) Filed: Oct. 5, 2007

(51) Int. Cl. G06E 1/00

(52) U.S. Cl. 706/20

(57) ABSTRACT

A method, system and computer-readable medium are presented for performing multiple-category classification of digital documents using non-binary classification approach that is less computationally intensive and does not require the generation of extra parameters in execution. The method comprises calculating a category score for categories to which a digital document may be classified. The category score is based on the relevance of the text in document. Threshold scores for each of the categories are determined to define a number of candidate relevance types. A candidate relevance type is determined for each the categories based upon the category scores. One or more of the categories are assigned to the document by applying a multiple-category selection rule to each of the categories. The candidate relevance type is used to determine whether the categories assigned to the digital document need further validation. If one or more of the assigned categories needs further validation, the validation is performed.

### BACKGROUND OF THE INVENTION

1. Technical Field of the Invention

The present invention relates in general to the field of machine learning, and in particular to computer-based supervised automatic classification of digital documents.

2. Description of the Related Art

Supervised Automatic Classification is a machine learning technique for creating a function from training data. In the learning stage, the technique extracts a characteristic word from training documents, which have been classified in advance by a person, generates parameters of a function for calculating a relevant score of each category by using a statistical method or the like, and stores the parameter in the knowledge base. In the execution state, the technique extracts a characteristic word from a document being classified, calculates a score from parameters in each category of a score function and selects the optimum category for the document.

Supervised Automatic Classification includes binary classification approaches (such as the Naïve Bayes approach, the Support Vector Machines approach and the like), which classify a document into categories one by one (whether it is included in the category or not). Supervised Automatic Classification also includes non-binary entire classification approaches (such as the Neural Network approach, the Bayesian network approach and the like), which classify a document into all categories at the same time.

Multiple-category classification, which assigns a multiple-category to a document, is known in the art. The multiple-category classification problem has been addressed in the prior art by the binary classification approach and the non-binary classification approach. The binary classification approach is limited in precision, as it does not consider a generation model for a multiple-category. For example, if there are two categories of “Sports” and “Business”, a document matching “Sports” and a document matching “Business” are classified into the multiple category of “Sports & Business” as the sum of sets. Assuming that words (terms t1 to t10) characterizing respective categories (Sports, Business, Sports & Business) are:

Sports: t1 to t7

Business: t4 to t10

Sports & Business (S&B): t4 to t7,

and characteristic words included in documents d1 and d2 are:

d1: t1, t2, t3, t8, t9, t10

d2: t1, t4, t5, t6, t10,

then both documents d1 and d2 are classified into “Sports & Business”. But, it is apparent that the document d1 does not match “Sports & Business”.

On the other hand, the non-binary classification approach is limited in efficiency. If the total number of categories is N, then theoretically, 2^{N}−1 types of training documents need to be prepared and 2^{N}−1 types of parameters need to be generated. If the total number of categories is 50, then the number of training documents and parameters that need to be generated is prohibitively large (i.e., 2⁵⁰−1), making such an approach impractical.

Japanese Laid-Open Patent Application No. 2004-46621 has mathematically proven the generation of a multiple classification model from a linear sum of single classification models. This technique only requires training documents by N types of single classifications. It has significantly improved efficiency by decreasing the number of times of generating parameters in execution up to N*(N+1)/2. However, this technique still has a problem in that a large number of categories, for example 100 categories, will require over 5000 generating parameters, which lowers efficiency.

### BRIEF SUMMARY OF TILE INVENTION

The present invention provides a method, system and computer program product for multiple-category classification using a non-binary classification approach that is less computationally intensive and does not require generation of extra parameters in execution. In one embodiment, the method comprises calculating a category score for categories to which a digital document may be classified. The category score is based on the relevance of the text in document. Threshold scores for each of the categories are determined to define a number of candidate relevance types. A candidate relevance type is determined for each the categories based upon the category scores. One or more of the categories are assigned to the document by applying a multiple-category selection rule to each of the categories. The candidate relevance type is used to determine whether the categories assigned to the digital document need further validation. If one or more of the assigned categories need further validation, the validation is performed.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary data processing system in which the present invention may be implemented;

FIG. 2 is a block diagram depicting a method 200 known in the art for supervised classification of digital documents;

FIG. 3 is a flowchart depicting a more efficient and less computationally intensive method for performing the classifying step 230 of FIG. 2 in accordance with one or more embodiments of the present invention;

FIG. 4 is a table 400 indicating threshold values of four exemplary categories in accordance with one or more embodiments of the present invention;

FIG. 5 is a table 500 depicting an exemplary multiple-category selection rule in accordance with one or more embodiments of the present invention; and

FIG. 6 shows two tables that depict exemplary category scores and category selections for twenty documents processed in accordance with one or more embodiments of the present invention.

### DETAILED DESCRIPTION OF THE INVENTION

An illustrative embodiment of the present invention is directed to a method, system and computer-readable medium encoded with a computer program product for multiple-category classification using a non-binary classification approach that does not require generation of extra parameters in execution. The present invention can take the form of an entirely hardware embodiment, an entirely software embodiment or an embodiment containing both hardware and software elements. In an illustrative embodiment, the invention is implemented in software, which may include, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The computer-readable medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

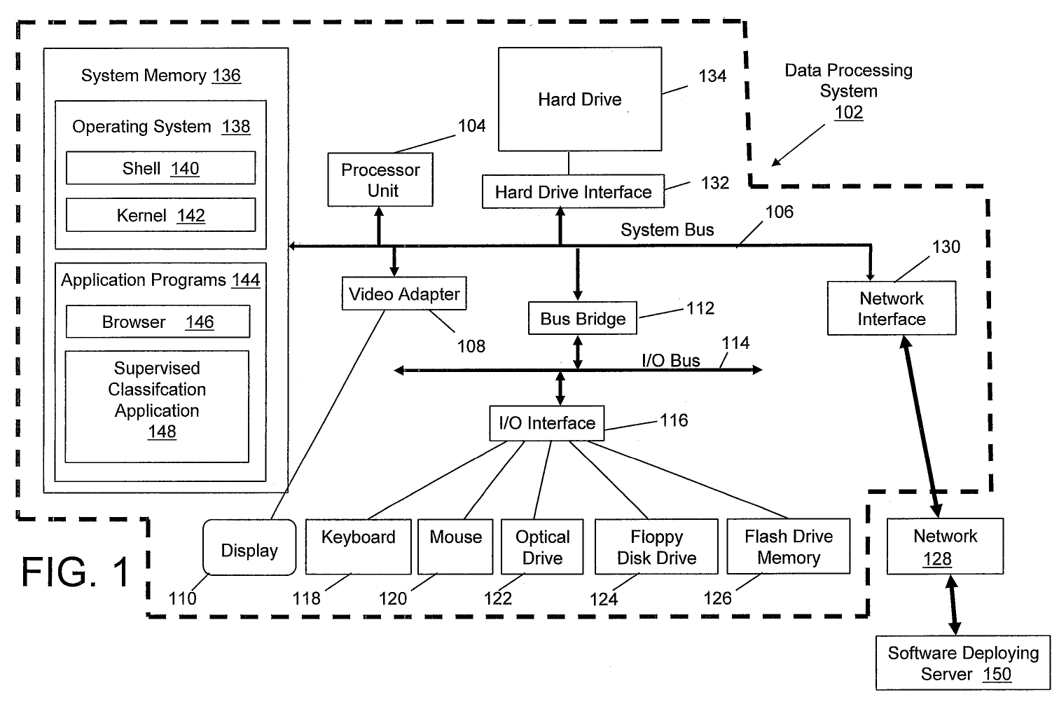

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative of one embodiment of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., data processing system 102) to send and receive network messages to the Internet using HyperText Transfer Protocol (HTTP) messaging, thus enabling communication with software deploying server 150.

Application programs 144 in the system memory of data processing system 102 (as well as the system memory of software deploying server 150) also include supervised classification application 148. Supervised classification application 148 comprises computer-executable code, at least a portion of which implements the method described herein. Supervised classification application 148 may reside in system memory 136, as shown, and/or may be stored in non-volatile bulk storage such as hard drive 134. In one embodiment, data processing system 102 is able to download supervised classification application 148 from software deploying server 150.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 150 performs all of the functions associated with the present invention (including execution of supervised classification application 148), thus freeing data processing system 102 from having to use its own internal computing resources to execute supervised classification application 148.

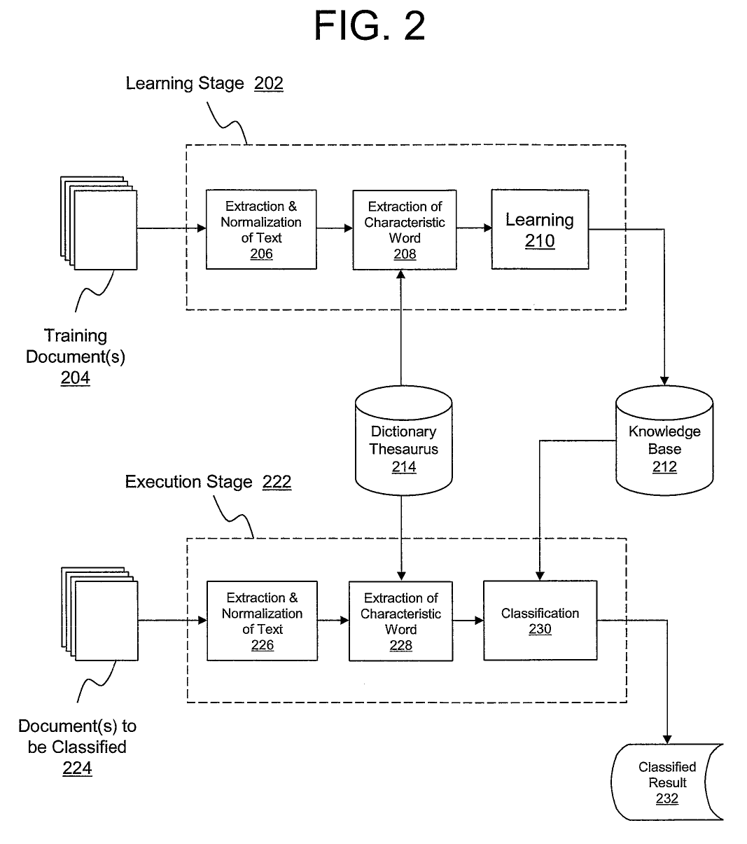

With reference now to FIG. 2, a block diagram is shown depicting a method 200 known in the art for supervised classification of digital documents. System 200 is comprised of two stages: learning stage 202 and execution stage 222. In learning stage 202, training documents 204 are used to compile knowledge base 212. Text is extracted from training documents 204 and normalized into a format understood by learning stage 202 (step 206). From the text extracted in step 206, characteristic words are identified in step 208. Identification of the characteristic words is aided by dictionary/thesaurus 214. The categories of training documents 204 are known, and in step 210 learning stage 202 uses this information to learn which words are characteristic of a category. The associations made during step 210 are stored in knowledge base 212 for use in execution stage 222. The knowledge base is created in a simple word extracting method (e.g., separating by spaces) from training documents 204.

In execution stage 222, one or more digital documents 224 are classified based upon characteristic words in each document. The text from document 224 is extracted and normalized into a format understood by execution stage 222 (step 226). From the text extracted in step 226, characteristic words are identified in step 228. Identification of the characteristic words is aided by dictionary/thesaurus 214. The characteristic words identified in step 228, along with information learned in the learning stage 202 and stored in knowledge base 212, are used to calculate scores for a number of potential categories to which document 224 may be classified. Based upon the scores of the categories, document 224 is classified into one or more categories in step 230 and the result is stored as classified result 232.

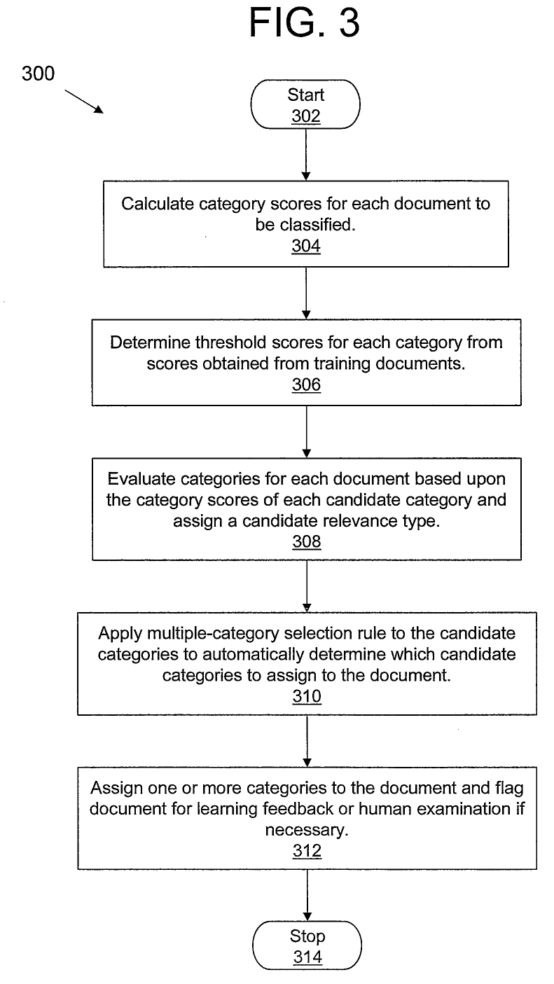

With reference now to FIG. 3, a flowchart is shown depicting a more efficient method for performing the classifying step 230 of FIG. 2. Process 300 starts at initiator block 302 and proceeds to step 304, where category scores are calculated for each document 224 that is to be classified. In the non-binary classification approach, relative strength among categories is reflected in the score (the strength is not reflected in the binary classification approach). The non-binary classification approach can also reflect correlation among the categories on the score by subtracting important words from the score as described below. That further improves precision of multiple-category selection. The score of the multiple-category is greater than the lowest score of a single category, which forms the multiple-category. If a document includes important words of categories A, B and C at the similar degree, when the categories A and B are very close and C alone is at a distance, then C has a lower score than A or B:
Score of category A ∝ Σt_{Ai}*f_{Ai}−(ΣS_{Bi}*f_{Bi}+ΣS_{ci}*f_{ci}),
Score of category B ∝ ΣS_{Bi}*f_{Bi}−(Σt_{Ai}*f_{Ai}+ΣS_{ci}*f_{ci}), and
Score of category C ∝ ΣS_{ci}*f_{ci}−(Σt_{Ai}*f_{Ai}+S_{Bi}*f_{Bi}); where
t_{Ai}: a characteristic value of a characteristic word of A;
S_{Ai}: a characteristic value of an important word of A (a characteristic word with a high characteristic value); and
f_{Ai}: frequency of appearance of a character word or an important word of A.

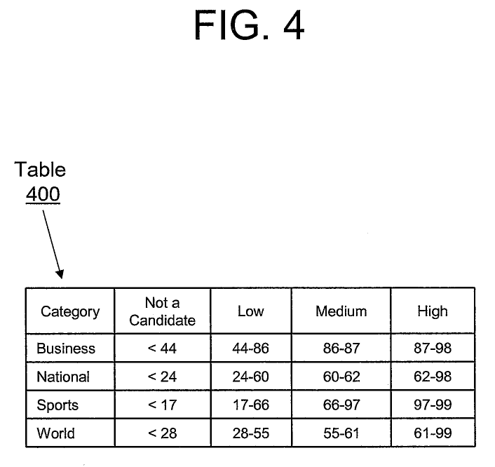

The score distribution of training documents 204 approximates the score distribution of documents 224. Since the distribution of scores differs for each category, threshold scores are determined for each category (step 306) from the scores obtained from training documents 204. The threshold scores subdivide the scores in each category into several candidate relevance types. If proportions of the numbers of documents for a given category are decided in advance (for example, 50% for high, 25% for medium and 25% for low), threshold scores are determined for each category as shown in table 400 of FIG. 4.

With reference now to FIG. 4, a table 400 indicating the threshold values of four exemplary categories is shown. Documents 224 are classified into one or more of four categories (e.g., Business, National, Sport and World) based upon the text of the documents and the category scores generated from the text. A category score in the “high” range indicates that the category is likely to have a high relevance to the document. A category score in the “medium” range indicates that the category is likely to have a medium relevance to the document. A category score in the “low” range indicates that the category is likely to have a low relevance to the document. A category score below the “low” range indicates that the category is not likely to have relevance to the document, and is not considered a candidate category for the document.

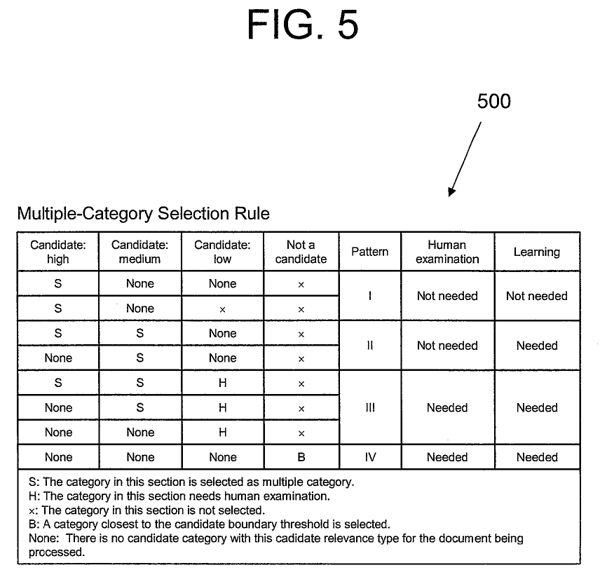

Returning now to FIG. 3, after the threshold scores are determined in step 306, categories are evaluated for each document 224 based upon the category scores of each candidate category and assigned a candidate relevance type (step 308). A multiple-category selection rule, based upon the number of candidate relevance types, is applied to the candidate categories to automatically determine which candidate categories to assign to the document (step 310). An example of such a multiple-category selection rule is shown in table 500 of FIG. 5. The categories selected by the multiple-category selection rule are then assigned to the document (step 312). Depending upon the candidate relevance types of the selected categories, the category assignment may be marked for feedback learning or human examination to determine whether the assignment is appropriate.

With reference now to FIG. 5, table 500 is shown depicting an exemplary multiple-category selection rule. Based on the distribution of the category scores calculated in step 304, a rule for selecting a multiple-category as shown in table 500 is created. Each row of table 500 indicates a possible combination of candidate categories for a particular document according to candidate relevance type. A candidate category with a candidate relevance type in a column marked with an “S” will be automatically selected as a category for the document. A candidate category with a candidate relevance type in a column marked with an “H” will be provisionally selected and requires human examination to determine whether it should be selected as a category for the document. A candidate category with a candidate relevance type in a column marked with an “x” will not be selected as a category for the document. A candidate category with a candidate relevance type in a column marked with a “B”, the candidate category closest to the candidate boundary threshold will be provisionally selected and requires human examination to determine whether it should be selected as a category for the document.

The selection rule in FIG. 5 gives rise to four category patterns for a document based upon whether feedback learning can be used to determine the categories for the document, or whether human examination is needed to make the determination. For patterns I and II, which have differences between the highest candidate relevance type and the other candidate relevance types, the category of the highest candidate relevance type present is selected for the document without human examination. For pattern III, with a more uniform distribution, the category with a “low” candidate relevance type needs human examination to determine whether that category should be assigned to the document. For pattern IV, without a candidate category (i.e., a category with a score higher than the boundary threshold), a category closest to the boundary value is selected, whose validity is subjected to human examination.

In the case of pattern I, the category (categories) classified into the “high” section is (are) selected. Human examination and feedback learning are not necessary to assign the category (categories) to the document. In the case of pattern II, the category (categories) classified into the “high” section and the “medium” section is (are) selected. Pattern II needs no human examination. The category (categories) in the “medium” section require feedback learning to be performed. In the case of pattern III, the category (categories) classified into the “high” section and the “medium” section is (are) selected. A person examines whether or not to select the category (categories) in the “low” section. Since the category (categories) in the “medium” section and below are present, feedback learning is performed. For pattern IV, a person examines whether the category closest to the candidate boundary threshold is optimum or not because no category candidate is present. As the optimum category is determined, feedback learning is performed.

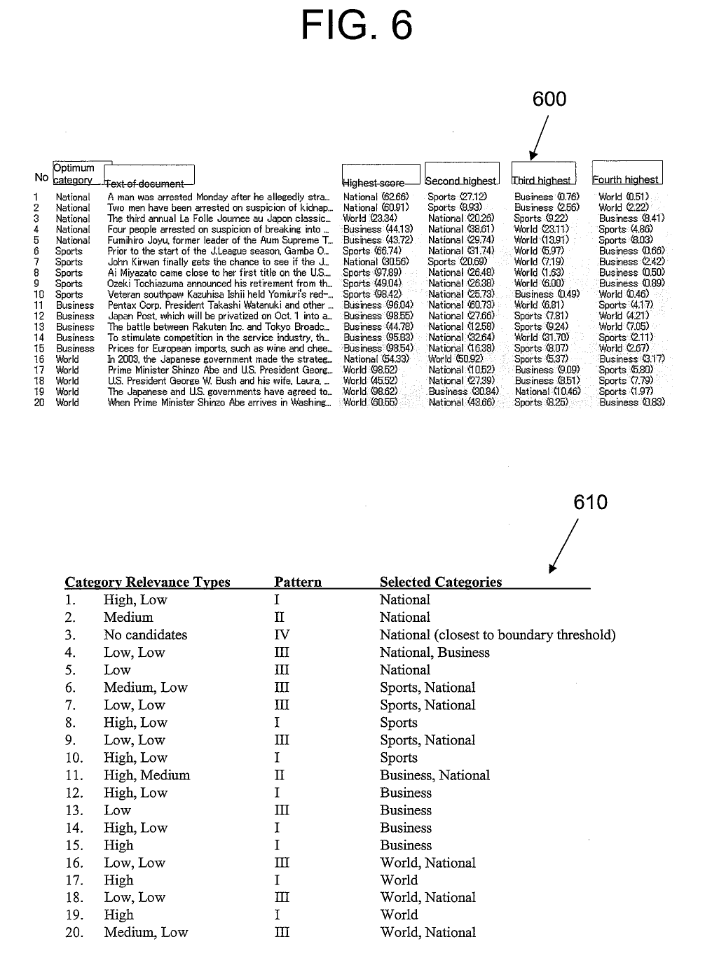

With reference now to FIG. 6, two tables are shown that depict exemplary category scores and category selections for twenty documents processed in accordance with one or more embodiments of the present invention. Table 600 shows a list a documents for which category score have been calculated. The category scores are shown in descending order from left to right. The optimum single category based on the highest category score is shown. Table 610 shows a list of documents for which categories have been assigned in accordance with one or more embodiments of the present invention, which enables the classification of multiple-categories. For example, the following category scores have been calculated for document 1 of table 600: National (62.66), Sports (21.12), Business (0.76) and World (0.51). “National” has category relevance type “high”, because (referring back to table 400 of FIG. 4) the score of 62.66 lies within the “high” range (62-98) for the “National” distribution of categories. “Sports” has category relevance type “low”, because the score of 27.12 lies within the “low” range (17-66) for the “Sports” distribution of categories. “Business” is not a candidate category, because the score of 0.76 lies below the baseline threshold score of 44 for the “Business” distribution of categories. Similarly, “World” is not a candidate category, because the score of 0.51 lies below the baseline threshold score of 28 for the “World” distribution of categories. Document 1 is therefore a pattern I document, having a “high” category relevance type (National), a “low” category relevance type (Sports) and no other candidate categories. Document 1 is automatically classified as a “National” document.

In another example, the following category scores have been calculated for document 6 of table 600: Sports (66.74), National (31.74), World (5.97) and Business (0.66). “Sports” has category relevance type “medium”, because the score of 66.74 lies within the “medium” range (66-97) for the “Sports” distribution of categories. “National” is a category of type “low”, because the score of 31.74 lies within the “low” range (24-60) for the “National” distribution of categories. “World” is not a candidate category, because the score of 5.97 lies below the baseline threshold score of 28 for the “World” distribution of categories. Similarly, “Business” is not a candidate category, because the score of 0.66 lies below the baseline threshold score of 44 for the “Business” distribution of categories. Document 6 is therefore a pattern III document, having a “medium” category relevance type (Sports), a “low” category relevance type (National) and no other candidate categories. Document 6 is automatically classified as a “Sports” document and feedback learning will be required to confirm the “Sports” classification. Document 6 is also provisionally classified as a “National” document and human examination will be required to confirm the “National” classification.

In a final example, the following category scores have been calculated for document 3 of table 600: World (23.34), National (20.26), Sports (9.22) and Business (8.41). “World” is not a candidate category, because the score of 23.34 lies below the baseline threshold score of 28 for the “World” distribution of categories. “National” is not a candidate category, because the score of 20.26 lies below the baseline threshold score of 24 for the “National” distribution of categories. “Sports” is not a candidate category, because the score of 9.22 lies below the baseline threshold score of 17 for the “Sports” distribution of categories. “Business” is not a candidate category, because the score of 8.41 lies below the baseline threshold score of 44 for the “Business” distribution of categories. Document 3 is therefore a pattern IV document, having no candidate categories. Document 3 is provisionally classified as a “National” document and human examination will be required to confirm the “National” classification. The reason document 3 is provisionally classified as “National” is because the category score for “National” was the category score closest to the categories boundary threshold score. The “National” category score (20.26) is within 3.74 of its boundary threshold value (24). The “World” category score (23.34), while higher than the “National” category score, is father away (4.66) from the boundary threshold score for the “World” category (28).

By reducing the number of documents that require human examination, this method is more efficient at performing supervised classification. Likewise, by reducing the number of training document and parameters needed for learning, this method is less computationally intensive in performing supervised classification.

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

Flowcharts and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A computer-based method for supervised classification of digital documents comprising:
automatically calculating, within a computer, a category score for each of a plurality of categories into which a digital document may be classified, wherein the category score is based on a plurality of words in the digital document;
automatically determining, within a computer, a plurality of threshold scores for each of said plurality of categories, wherein the threshold scores define a plurality of candidate relevance types;
automatically determining, within a computer, a candidate relevance type for each of said plurality of categories based upon the category score of each of said plurality of categories;
assigning one or more of said plurality of categories to the digital document by applying a multiple-category selection rule to each of said plurality of categories;
determining whether the one or more categories assigned to the digital document need further validation, wherein said determination is based upon the candidate relevance type of the assigned categories;
in response to determining that the one or more categories assigned to the digital document need further validation, performing said validation; and
in response to determining that the one or more categories assigned to the digital document does not need further validation, not performing said validation.

2. The method of claim 1, wherein the validation of said one or more categories assigned to the digital document comprises feedback learning.

3. The method of claim 1, wherein the validation of said one or more categories assigned to the digital document comprises human examination.

4. A system for computer-based supervised classification of digital documents comprising:
means for automatically calculating, within a computer, a category score for each of a plurality of categories into which a digital document may be classified, wherein the category score is based on a plurality of words in the digital document;
means for automatically determining, within a computer, a plurality of threshold scores for each of said plurality of categories, wherein the threshold scores define a plurality of candidate relevance types;
means for automatically determining, within a computer, a candidate relevance type for each of said plurality of categories based upon the category score of each of said plurality of categories;
means for assigning one or more of said plurality of categories to the digital document by applying a multiple-category selection rule to each of said plurality of categories;
means for determining whether the one or more categories assigned to the digital document need further validation, wherein said determination is based upon the candidate relevance type of the assigned categories;
means, responsive to determining that the one or more categories assigned to the digital document need further validation, for performing said validation; and
means, responsive to determining that the one or more categories assigned to the digital document does need further validation, for performing said validation.

5. The system of claim 4, wherein the means for performing validation of said one or more categories assigned to the digital document comprises means for feedback learning.

6. The system of claim 4, wherein the means for performing validation of said one or more categories assigned to the digital document comprises means for human examination.

7. A computer-readable medium encoded with a computer program that, when executed, causes the control circuitry of a data processing system to perform steps for supervised classification of digital documents comprising:
automatically calculating, within a computer, a category score for each of a plurality of categories into which a digital document may be classified, wherein the category score is based on a plurality of words in the digital document;
automatically determining, within a computer, a plurality of threshold scores for each of said plurality of categories, wherein the threshold scores define a plurality of candidate relevance types;
automatically determining, within a computer, a candidate relevance type for each of said plurality of categories based upon the category score of each of said plurality of categories;
assigning one or more of said plurality of categories to the digital document by applying a multiple-category selection rule to each of said plurality of categories;
determining whether the one or more categories assigned to the digital document need further validation, wherein said determination is based upon the candidate relevance type of the assigned categories;
in response to determining that the one or more categories assigned to the digital document need further validation, performing said validation; and
in response to determining that the one or more categories assigned to the digital document does not need further validation, not performing said validation.

8. The computer-readable medium of claim 7, wherein the validation of said one or more categories assigned to the digital document comprises feedback learning.

9. The computer-readable medium of claim 7, wherein the validation of said one or more categories assigned to the digital document comprises human examination.
